(19) United States
(12) Patent Application Publication
(10) Pub. No.: US 2002/0096031 A1
(43) Pub. Date: Jul. 25, 2002

(54) Manual paper cutter

(76) Inventor: Shao-Ping Yang, Taichung (TW)

Correspondence Address: Shao-Ping Yang, P.O. Box 453, Taichung, TW

(21) Appl. No.: 09/765,309

(22) Filed: Jan. 22, 2001

(51) Int. Cl. B26D 5/08; B26D 1/18

(52) U.S. Cl. 83/614; 83/564; 83/485; 83/658

(57) ABSTRACT

A manual paper cutter comprises a rule, a guide rail disposed on the rule, and a cutting device mounted on the guide rail. The cutting device comprises a housing, a guide seat, and a blade mount. The housing is provided in the interior with a receiving space, a retaining pillar, and a receiving slot. The guide seat is provided with a through slot and a guide slot which is provided with a locating slot corresponding in location to the retaining pillar. The blade mount is disposed in the receiving slot and is provided with a blade opposite in location to the through slot of the guide seat. The retaining pillar is provided with a spring fitted thereover. As the housing is pressed, the blade is actuated to jut out of the through slot of the guide seat.

### BACKGROUND OF THE INVENTION

1. Field of the Invention

The present invention relates generally to a cutting device, and more particularly to a manually-operated paper cutter.

2. Description of Related Art

As shown in FIGS. 1 and 2, paper cutting device of the prior art comprises a rule 17, a rail 16 mounted on one long side of the rule 17, a housing 10 slidably mounted on the rail 16, a blade 14 mounted on a blade seat 13, and a spring 15 disposed between a seat body 11 of the housing 10 and a press button 12 pivoted to the housing 10. In operation, the press button 12 is pressed with finger so as to cause the blade 14 to move downward to cut the paper. This prior art cutting device is defective in design in that the pressing of the press button 12 with finger in a repeated manner can easily bring about discomfort to the hand of a user of the paper cutting device.

### BRIEF SUMMARY OF THE INVENTION

The primary objective of the present invention is to provide a manual paper cutter which is free of the drawback of the prior art cutter described above.

In keeping with the principle of the present invention, the foregoing objective of the present invention is attained by the manual paper cutter comprising a housing, a guide seat, and a blade mount. The housing is provided in the interior with a receiving space in which a retaining pillar and a receiving slot are located. The guide seat is provided with a through slot and a guide slot which is provided with a locating slot corresponding in location to the retaining pillar. The blade mount is disposed in the receiving slot and is provided with a blade. The retaining pillar is provided with a spring fitted thereover and is retained in the locating slot. The cutter of the present invention can be manually operated with ease.

### BRIEF DESCIPTION OF THE SEVERAL VIEWS OF THE DRAWINGS

FIG. 1 shows a perspective view of the prior art.

FIG. 2 shows a schematic view of the prior art in action.

FIG. 3 shows a perspective view of a preferred embodiment of the present invention.

FIG. 4 shows an exploded view of the preferred embodiment of the present invention.

FIG. 5 shows a schematic view of the housing and the blade mount of the preferred embodiment of the present invention.

FIG. 6 shows a sectional schematic view of the preferred embodiment of the present invention in action.

FIG. 7 shows another sectional schematic view of the preferred embodiment of the present invention in action.

FIG. 8 shows a schematic view of a locating member of the preferred embodiment of the present invention in action.

FIG. 9 shows a schematic view of the preferred embodiment of the present invention in operation.

FIG. 10 shows another schematic view of the preferred embodiment of the present invention in operation.

FIG. 11 shows a schematic view of the preferred embodiment of the present invention at work.

FIG. 12 shows a schematic view of another preferred embodiment of the present invention.

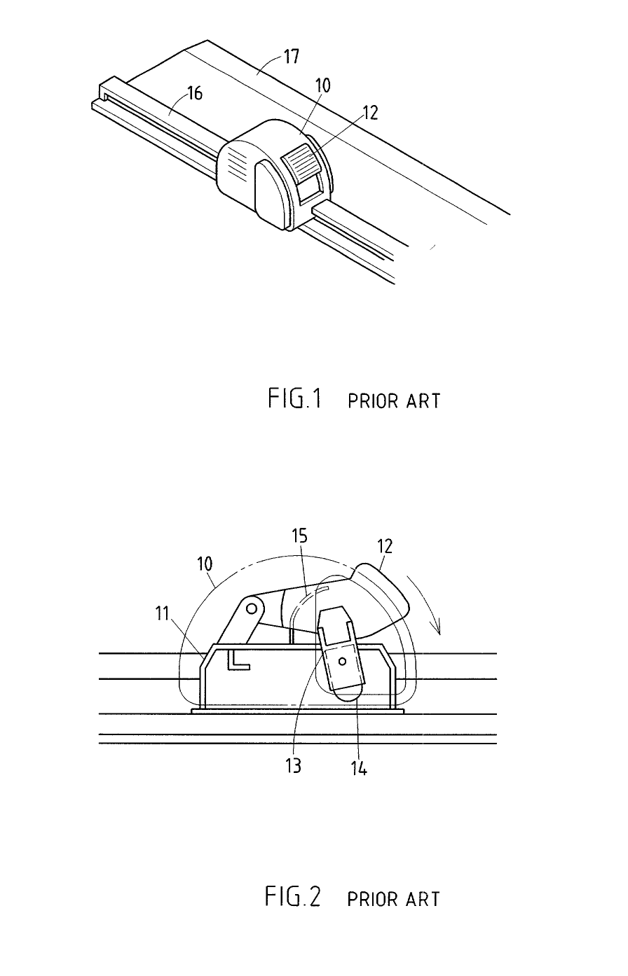

### DETAILED DESCRIPTION OF THE INVENTION

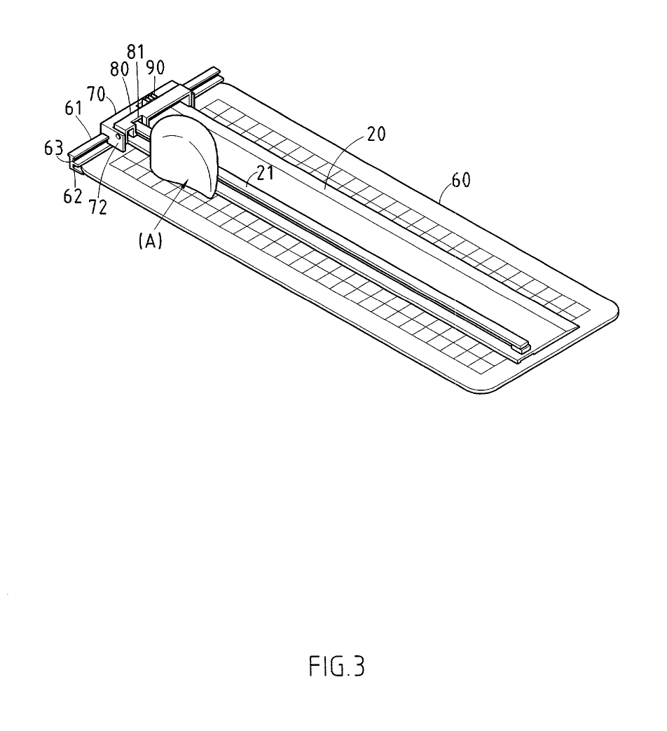

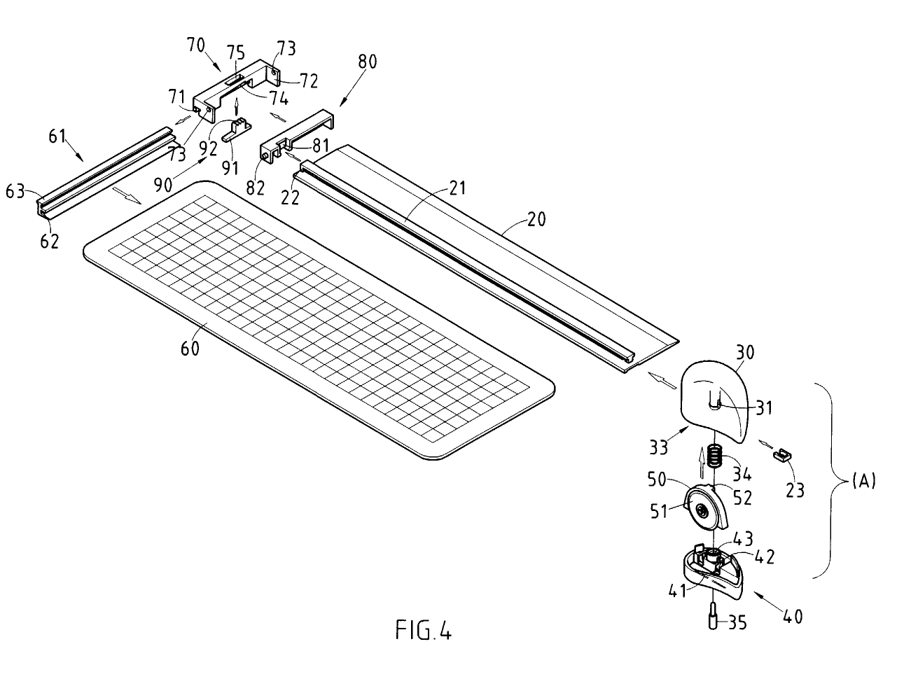

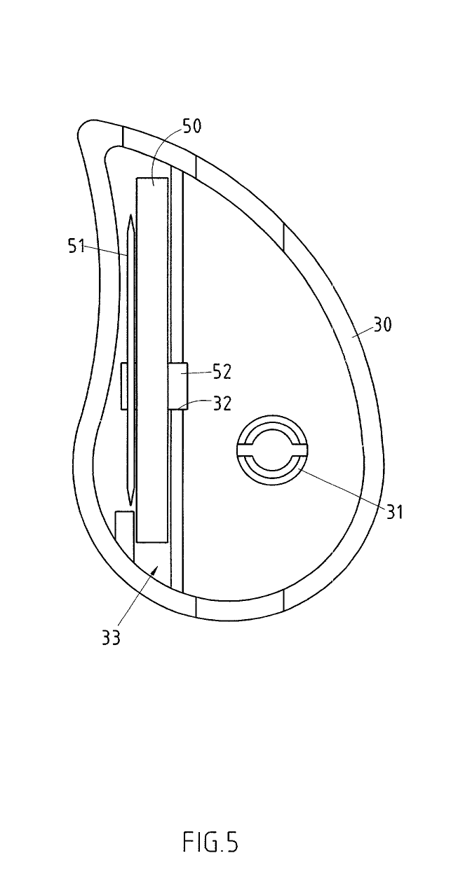

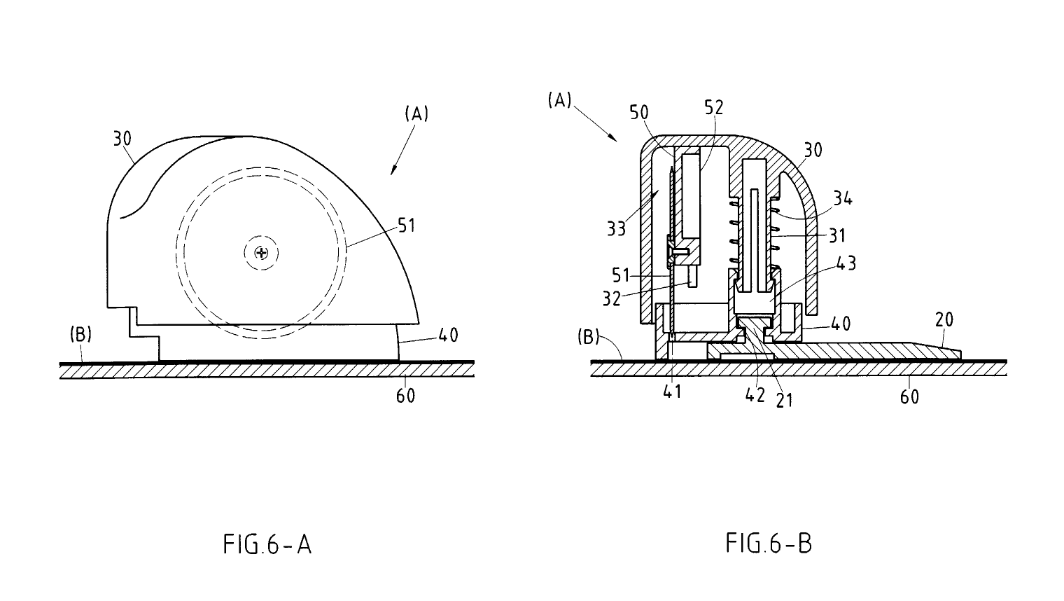

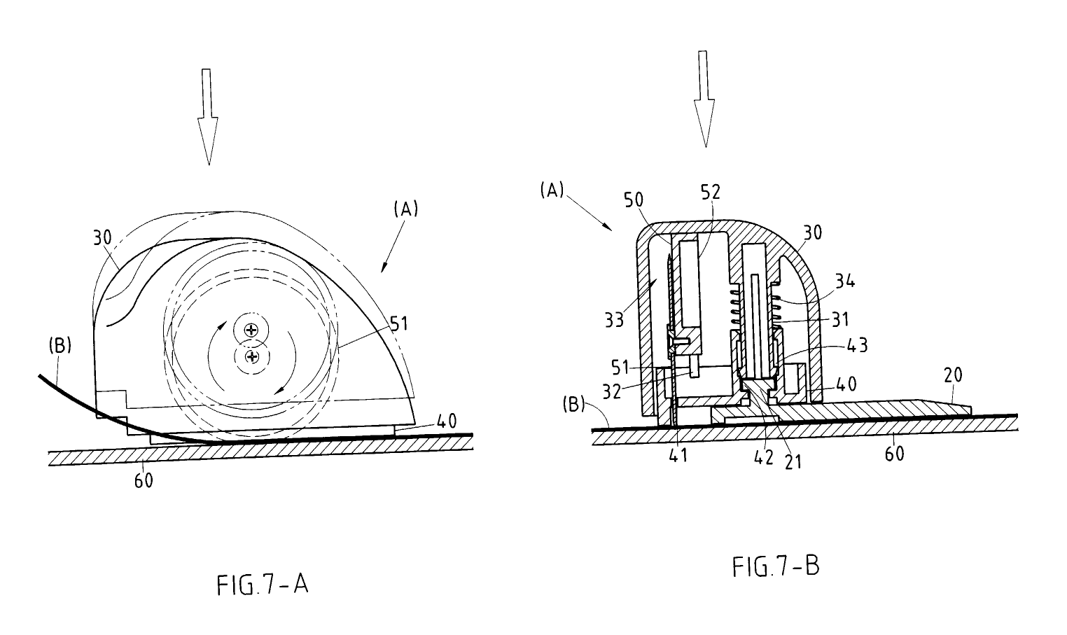

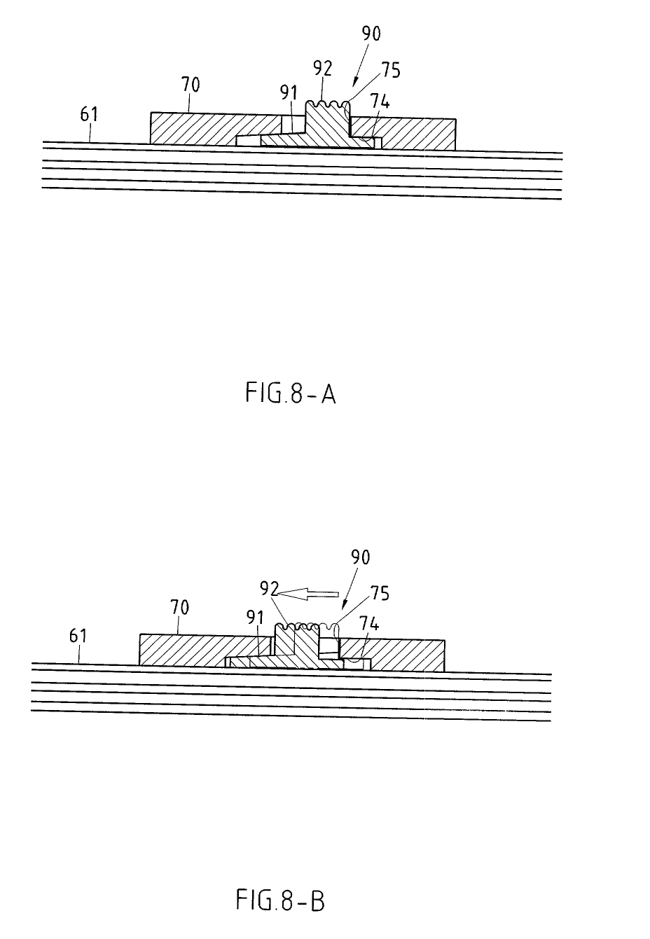

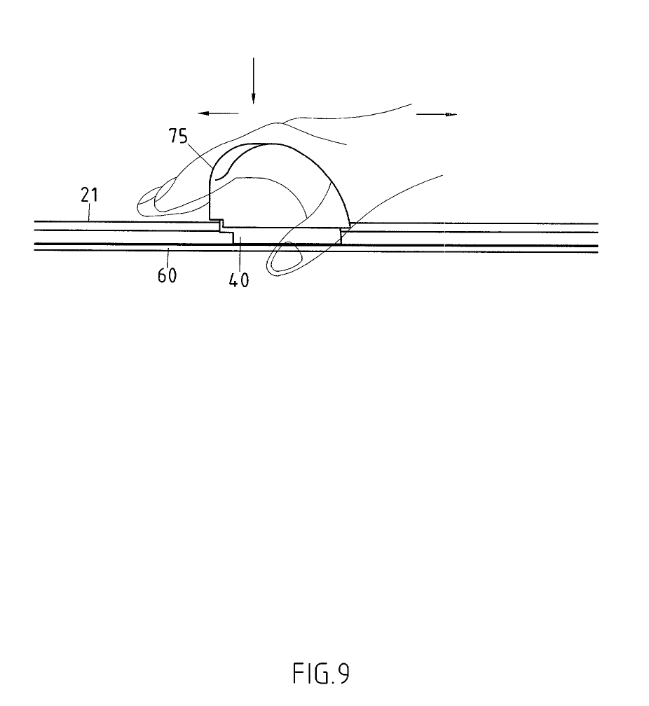

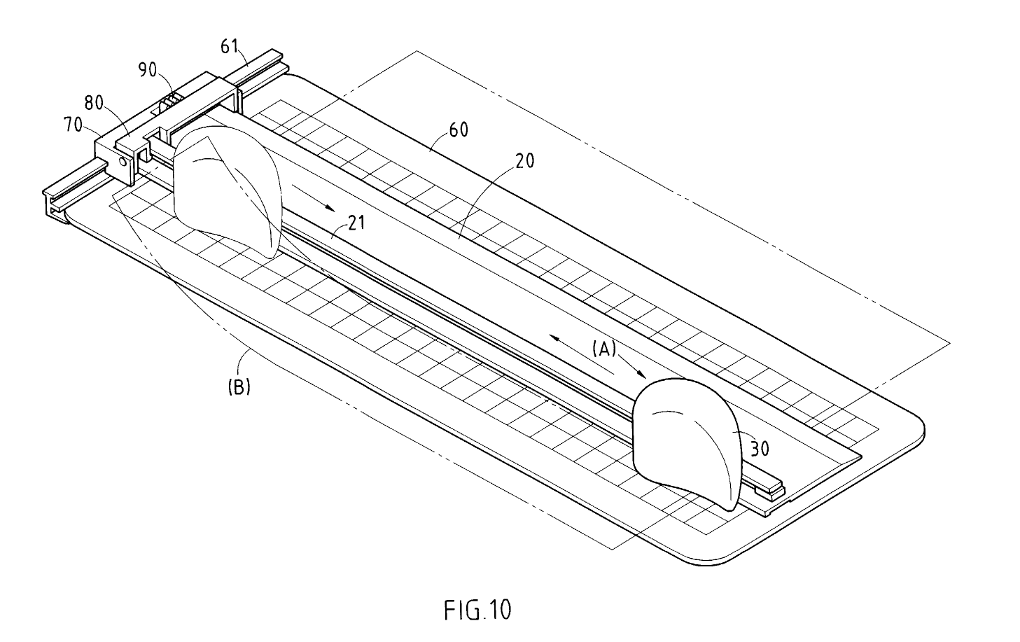

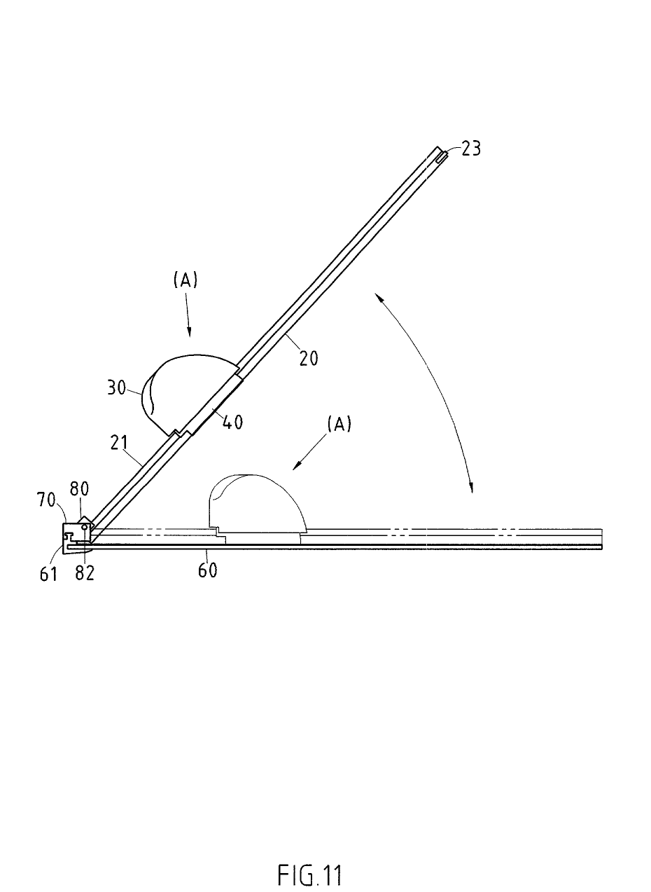

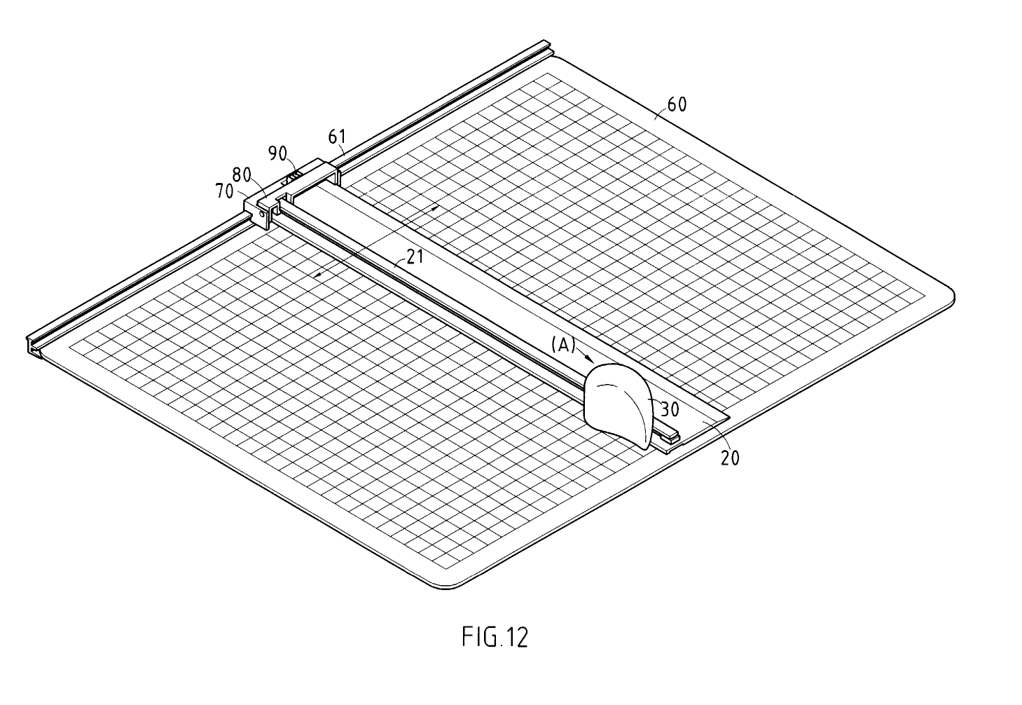

As shown in FIGS. 3-12, a paper cutter of the present invention comprises a rule 20, a T-shaped guide rail 21., and a cutting device A slidably mounted on the guide rail 21.

The cutting device A comprises a housing 30, a guide seat 40, and a blade mount 50.

The housing 30 is provided in the interior with a receiving space and a receiving slot 33. The receiving space is provided with a retaining pillar 31. The receiving slot 33 is provided with a guide slide slot 32.

The guide seat 40 is provided in one side with a through slot 41, and in other side with a guide slot 42 which is in turn provided with a locating slot 43.

The blade mount 50 is disposed in the receiving slot 33 of the housing 30 and is provided in one side with a blade 51 pivoted therewith. The blade mount 50 is further provided in other side with a guide block 52. The blade mount 50 is disposed in the receiving slot 33. The retaining pillar 31 of the housing 30 is provided with a spring 34 fitted thereover. The retaining pillar 31 is retained in the locating slot 43 of the guide seat 40 by a pin 35, so as to enable the housing 30 to be pivoted with the guide seat 40. In the meantime, the blade 51 of the blade mount 50 is opposite in location to the through slot 41 of the guide seat 40. As the housing 30 is pressed to displace downward, the blade 51 is jutted out of the through slot 41. The guide slot 42 is located on the T-shaped guide rail 21 of the rule 20. The housing 30 is provided with a large area surface on which a user's hand can easily hold and press.

The T-shaped guide rail 21 is equal in length to the rule 20 and is provided at one end with a stop edge 22. The T-shaped guide rail 21 is further provided at other end with an inverted U-shaped stop block 23 for confining the cutting device A.

The paper cutter of the present invention further comprises a pad 60 which is provided with a slide rail 61.

The slide rail 61 is provided with an upper seat body 70 pivoted therewith. The upper seat body 70 has a fixation seat 80 to which the rule 20 is fastened in such a manner that rule 20 can be slid on the pad 60.

The slide rail 61 is provided with a connection slot 62 for connecting the pad 60, and a T-shaped rib 63 corresponding to a T-shaped slide slot 71 of the upper seat body 70.

The upper seat body 70 is provided in two sides with a lug 72 which is provided with a through hole 73. The fixation seat 80 is provided in two sides with a projection 82 corresponding in location to the through hole 73 of the lug 72. The fixation seat 80 is pivoted with the upper seat body 70. The rule 20 can be thus lifted.

The fixation seat 80 is provided with a recess 81 corresponding in location to the T-shaped guide rail 21 of the rule 20.

The upper seat body 70 is further provided with a position confining slot 74 and a through slot 75 for pivoting a locating member 90 which has a seat portion 91 being confined by the position confining slot 74 of the upper seat body 70. The locating member 90 further has a button 92 which is jutted out via the through slot 75.

The top edge of the position confining slot 24 and the seat portion 91 of the locating member 90 are slanted to facilitate the adjusting of the upper seat body 70.

The housing 30 is shaped to fit easily into the palm of a user's hand. As the housing 30 is pressed by the hand, the blade mount 50 is actuated to displace downward, thereby causing the blade 51 to jut out of the through slot 41 to execute the cutting of the paper B which is located between the rule 20 and the pad 60. As the housing 30 is relieved of the pressure exerting thereon, the blade 51 is retracted into the guide seat 40.

I claim:

1. A manual paper cutter comprising a rule, a T-shaped guide rail disposed on said rule, and a cutting device mounted on said T-shaped guide rail; wherein said cutting device comprises:
a housing provided in an interior with a receiving space and a receiving slot, said receiving space being provided with a retaining pillar, said receiving slot being provided with a guide slide slot;
a guide seat provided in one side with a through slot, and in other side with a guide slot which is in turn provided with a locating slot; and
a blade mount disposed in said receiving slot of said housing and provided in one side with a blade pivoted therewith, said blade mount further provided in other side with a guide block;
said retaining pillar of said housing being provided with a spring fitted thereover, said retaining pillar being retained in said locating slot of said guide seat by a pin, thereby enabling said housing to be pivoted with said guide seat, said blade of said blade mount being opposite in location to said through slot of said guide seat such that said blade is jutted out of said through slot at the time when said housing is pressed to displace downward.

2. the manual paper cutter as defined in claim 1, wherein said T-shaped guide rail is equal in length to said rule and is provided at one end with a stop edge, said T-shaped guide rail being provided at other end with an inverted U-shaped stop block for confining said cutting device.

3. The manual paper cutter as defined in claim 1, wherein said cutting device further comprises a pad which is provided with a slide rail and slide rail being provided with an upper seat body pivoted therewith whereby said upper seat body has a fixation seat, said rule being fastened to said fixation seat in such a manner that said rule can be slide on said pad.

4. The manual paper cutter as defined in claim 3, wherein said slide rail is provided with a connection slot for connecting said pad and is further provided with a T-shaped rib corresponding to a T-shaped slide slot of said upper seat body.

5. The manual paper cutter as defined in claim 3, wherein said upper seat body is provided in two sides with a lug which is provided with a through hole; wherein said fixation seat is provided in two sides with a projection corresponding in location to said through hole of said lug whereby said fixation seat is pivoted with said upper seat body.

6. The manual paper cutter as defined in claim 3, wherein said fixation seat is provided with a recess corresponding in location to said T-shaped guide rail of said rule.

7. The manual paper cutter as defined in claim 3, wherein said upper seat body is further provided with a position confining slot and a through slot for pivoting a locating member, said locating member having a seat portion which is confined by said position confining slot of said upper seat body, said locating member further having a button whereby said button is jutted out via said through slot of said upper seat body.

8. The manual paper cutter as defined in claim 7, wherein said position confining slot has a slanted top edge; wherein said seat portion of said locating member is slanted.
